(19) United States
(12) Patent Application Publication
(10) Pub. No.: US 2002/0096195 A1
(43) Pub. Date: Jul. 25, 2002

(54) Method and apparatus for critical flow particle removal

(75) Inventors: Stefanie Harvey, Sunnyvale, CA (US); Peter Satitpunwaycha, Santa Clara, CA (US); Kallol Bera, San Jose, CA (US)

Correspondence Address: Patent Counsel, M/S 2061, Legal Affairs Dept., P.O. Box 450A, Santa Clara, CA, 95052, US

(73) Assignee: APPLIED MATERIALS, INC., Santa Clara, CA (US)

(21) Appl. No.: 10/037,943

(22) Filed: Jan. 4, 2002

Related U.S. Application Data
(60) Provisional application No. 60/259,843, filed on Jan. 4, 2001.

(51) Int. Cl. B08B 5/00

(52) U.S. Cl. 134/21

(57) ABSTRACT

In a substrate cleaning apparatus, particles attached to the surface of the substrate are dislodged and removed using a shock wave created by high-speed flow of a gas stream in a tube or slot that is juxtaposed with respect to the surface to be cleaned. The shock wave is generated in a controlled gap between the substrate and the tube or slot. The pressure differential may result from either a reduced pressure or an increased pressure in the tube or slot with respect to an external pressure. With this technique, particles and process residue (from etch, CMP, etc.) may be effectively removed from the surface. The substrate may be a reticle or a semiconductor wafer, though other types of substrates, including other substrates used in semiconductor manufacturing processes, also may be cleaned.

The present application claims benefit of Provisional Application No. 60/259,843, filed Jan. 4, 2001.

### BACKGROUND OF THE INVENTION

1. Field of the Invention

The present invention relates to techniques for cleaning surfaces of articles to remove contamination. In particular, the present invention relates to cleaning surfaces of substrates, including semiconductor wafers, reticles, glass, or other articles to remove particles and other contaminants, using a shock wave produced by high speed flow of a gas stream.

2. Description of the Related Art

Modem microelectronic devices such as microprocessors and memory chips are comprised of a plurality of layers typically provided on the surface of a semiconductor wafer. Fabrication of semiconductor devices typically involves creating circuit elements such as transistors on or in the upper surface of the substrate, and then forming wiring to interconnect the circuit elements. In one manufacturing technique, this wiring is formed by depositing a layer of dielectric such as silicon dioxide on the surface of the wafer, etching a pattern in the silicon dioxide to leave behind trenches and/or throughholes, and depositing a metal layer over the patterned dielectric, as well as in the trenches and holes. The metal extending above the dielectric is then removed, either entirely or selectively (wherein patterns are etched in the metal and then filled with dielectric). This process may be repeated multiple times to form multiple wiring layers. These fabrication steps typically are performed in air-tight process chambers operating at interior gas pressures below atmospheric pressure.

If the wafer surface contains certain contaminants, such as microscopic particles, semiconductor devices manufactured using such a wafer may be defective, because the particles can prevent deposition into an etched feature, or may conductively span a feature. Wafer surface contamination is one of the major causes of reduced yield of the number of usable “dice,” or chips, recoverable from a completed wafer. Therefore, it will be appreciated by those skilled in the art that it is desirable to keep the surfaces of the semiconductor wafers free from any contaminants during manufacture of semiconductor devices. However, it also is apparent that contaminants often are inherent in the processes used in this manufacture.

Various methods have been developed for stripping and cleaning substrate surfaces to remove foreign particles attached thereto, while avoiding the damage to the surface itself. Such methods are predominantly either chemical or mechanical, or a combination of the two. Energy beams, such as laser beams, e beams, or ion beams, also have been used.

The chemical and mechanical processes currently available for cleaning semiconductor substrates have certain limitations. First, many of those processes primarily are limited to the cleaning of raw substrates, i.e., substrates on which circuit fabrication steps have not yet been performed. Further, such processes may not clean the substrates sufficiently. Many conventional substrate cleaning techniques remove only the oxide layer that can form thereon when oxidizable features on the substrate are exposed to oxygen. Degas processes generally only remove volatizable materials, such as water vapor, from the surface pores of the substrate and do not remove particles which remain on the surface of the substrate. Electrostatic systems, which require a static buildup between a reference electrode and the wafer, have been only partially effective, and often require in-chamber hardware modifications. Some methods, such as laser-steam evaporation, remove particles by depositing a layer of liquid, then flash evaporate the liquid film by a laser pulse, so as to remove particles from the surface and put them into the ambient atmosphere or vacuum.

Accordingly, there exists a need for a substrate cleaning method which would provide for dislodging and removal of particles from the surface without contacting and damaging the surface itself.

### SUMMARY OF THE INVENTION

In view of the foregoing, it is one feature of the present invention to provide a method and apparatus for cleaning surfaces of substrates of particles and other contaminants without damaging the surface. According to the invention, a shock wave is created to remove the particles.

To create the shock wave, in one embodiment, a vacuum tube or slot is provided, inside a clean gas environment, as for example, within a process chamber. Also within the chamber is a substrate having a surface with particles to be removed. A shock wave is formed between a tip of the tube or slot, and the surface, by creating an appropriate pressure differential between the vacuum and the gas environment. The.shock wave causes the particles to be dislodged. The gas and the dislodged particles are removed from the surface by the vacuum tube.

In a variant of the first embodiment, a gas supply tube or slot supplies a gas stream toward the surface of the substrate. The tube is provided in a vacuum or low pressure laminar flow environment; again, the environment could be a process chamber. The high speed gas flow from within the tube to outside the tube forms a shock wave for dislodging the particles, resulting at least in part from a pressure differential between the pressure at which the gas is emitted and the lower pressure outside the tube. The tip of the gas supply tube is disposed so as to form a predetermined gap between the surface to be cleaned and the gas supply tube; the shock wave is formed within this gap.

In yet another embodiment, a vacuum pump is provided, along with a vacuum tube or slot connected to the vacuum pump, so as to create a flow of ambient gas from an environment (where the substrate or item to be cleaned resides) into the vacuum tube. The flow of the aforementioned ambient gas forms a shock wave, which dislodges particles from the surface. Appropriate control of process parameters, such as tube or slot cross-section at the tip; gas flow; and size of the gap between the tube or slot and the surface to be cleaned, will cause the shock wave to be formed at the surface to be cleaned, rather than in the tube or slot.

### BRIEF DESCRIPTION OF THE DRAWINGS

The present invention will now be described in detail with reference to the attached drawings, wherein:

FIG. 1 shows a substrate cleaning device according to a first embodiment of the present invention.

FIG. 2 shows a substrate cleaning device according to a variant of the first embodiment of the present invention.

FIGS. 3-8 show a substrate cleaning device according to variants of the first embodiment of the present invention.

FIG. 9 shows a simulated flow velocity distribution for the embodiment of the inventive substrate cleaning apparatus of FIG. 1.

FIG. 10 shows a substrate cleaning device according to a second embodiment of the present invention.

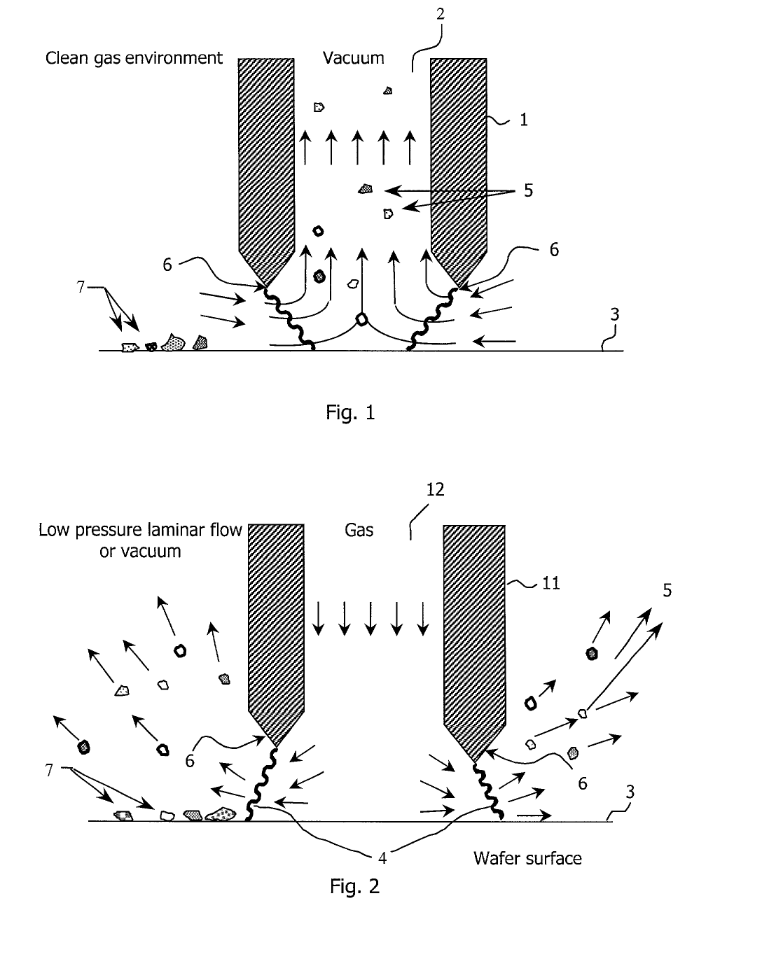

FIGS. 1A and 11B are plan views of portions of the first and second embodiments.

### DETAILED DESCRIPTION OF THE PREFERRED EMBODIMENTS

Preferred embodiments of the present invention now will be described with reference to the attached drawings, wherein identical elements are designated with corresponding numerals.

One of the features of the invention is the use of standing shock waves generated as a result of a controlled gap and a pressure drop between the surface of a substrate to be cleaned, and the gas flow apparatus, to overcome forces (Van der Waal forces, covalent forces, and the like) that bind physisorbed and chemisorbed particles to the surface. The inventive method relies on kinetic energy generated by the manipulation of gas flow and vacuum, rather than on an external energy source (laser, megasonic, and the like) or a chemical or mechanical approach. Because no external energy source is involved, the likelihood of damage to the surface of the substrate is reduced.

The present invention can be used to remove particles and process residues (from etch, chemical mechanical processes (CMP), etc.) from the surfaces of substrates, reticles, and the like.

In a first embodiment, shown in FIG. 1, a tube or slot 1 is connected to a vacuum source (not shown). A substrate 3, such as a semiconductor wafer, reticle, or other article having particles (or other residue) on its surface is placed in a clean gaseous environment so that a controlled gap is provided between the tube or slot 1 and the substrate 3. The aforementioned gap between the substrate 3 and the tube or slot 1 has a combined dimension (the height of the gap, multiplied by the perimeter of the tube or slot) sufficiently small so that, as the gas exits the chamber into the lower pressure regions of the tube, a standing shock wave forms between the tube or slot 1 and the substrate 3, based, among other things, on a pressure differential between the environment outside the tube and the vacuum within the tube or slot. The shock wave is produced by ambient clean gas rushing into the vacuum created by the tube or slot; the gas flow is sufficiently high to approach supersonic speeds.

Depending on design considerations such as the shape of the opening of the tube or slot, and the gap between the substrate surface to be cleaned and the tube or slot, the gas pressure differential could be as little as 76 torr, but could be 760 torr, 1520 torr, or more, if the chamber is pressurized above atmospheric pressure. The cross-sectional area within the tube or slot is sized so as to achieve the desired pressure differential efficiently. Due consideration may be given to the areal cross-section of the tube or slot relative to the substrate to be cleaned; for example, the larger the areal cross-section of the tube or slot relative to the substrate to be cleaned, the more effort required to achieve the desired pressure differential, but the more rapid the cleaning.

The gas flow phenomenon used in the present invention is known as critical (or “choked”) flow. More specifically, gas flow into the tube is substantially limited because of the presence of the shock wave. The shock wave is a region of very high energy density, wherein gas molecules decelerate and accelerate at high rates (hundreds of Gs or gravitational units). When the shock wave is directed to a location with particles, it can impart enough kinetic energy to the particles to dislodge them from the wafer. In FIG. 1, once the particles 5 are dislodged from the surface by the shock wave, they are entrained into the gas stream 2 which is pumped away from the substrate 3 by the vacuum within the tube or slot.

In operation, the tube or slot 1 is moved in a radial/tangential path, or in raster fashion, across a contaminated substrate. Where it is swept in a radial/tangential path, rotation of the substrate can speed up the cleaning process. Of course, instead of moving the tube/slot, the substrate itself may be moved; further, both the tube/slot and the substrate may be moved. It is relative movement between the substrate and the tube/slot that allows the cleaning region beneath the tube/slot to sweep the entire substrate area. As particles are dislodged they also are sucked into the tube and thus are removed from the chamber.

The tube or slot also may be moved directly to one or more selected areas, and those selected areas of the substrate then can be cleaned selectively. The control of relative motion between the substrate and the tube/slot also allows application of different cleaning strengths to different parts of the substrate. Also, it should be noted that, particularly where a slot is used, the slot can be sized to be greater in length than the length or width of the substrate to be cleaned. With this sizing, the substrate can be cleaned in a single pass between the slot and the substrate.

While for the most part the description herein refers to a tube, it should be appreciated that a slot opening in a manifold, or other arrangements providing for a pressure drop and shock wave, likewise are acceptable. A plurality of tubes or slots also could be provided. For cleaning on one surface of the substrate, a single tube/slot or plurality of tubes/slots could be used, but for cleaning on both surfaces, tubes/slots could be provided on both sides of the substrate. Also, it should be noted that this embodiment of the invention can be used in an atmospheric environment of semiconductor manufacturing equipment such as the factory interface, though the embodiment also can be used in other applications, such as a cleaning station. Other applications will be apparent to those of working skill in this technological field.

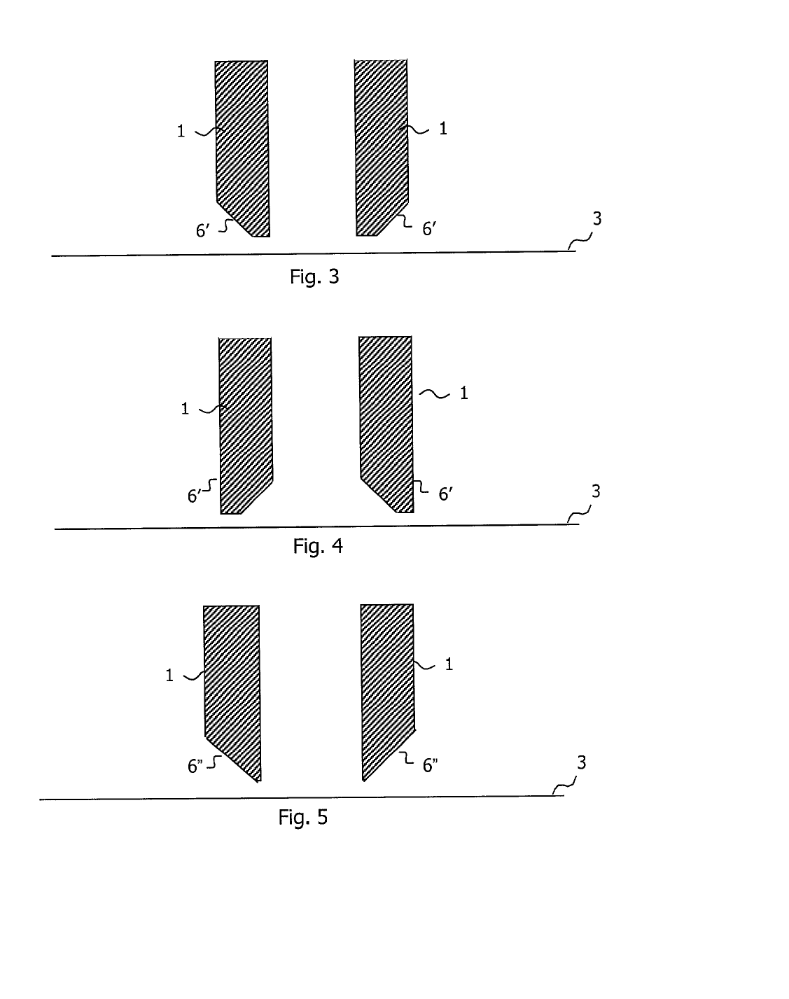

FIG. 2 shows a variant of the invention in which the tube or slot 11 is a source of gas (such as clean gas, for example), which flows in the opposite direction from the embodiment of FIG. 1, i.e. outward from the tube, through the controlled gap, to create the shock wave 4. The environment of the surface being cleaned is a vacuum or a low pressure environment, which allows laminar flow entrainment of dislodged particles. The particles 7 again are dislodged by the creation of the standing shock wave 4 between the apparatus 1 and the substrate 3. However, because of the opposite direction of flow, in the second embodiment the particles are blown outwardly, away from the apparatus, and are entrained by the ambient gas flow 5. This variant is suited for use in a low or high vacuum environment of a cluster tool (a transfer chamber having one or more process chambers coupled thereto). It can occupy one of the chamber positions of the cluster tool, for example a cleaning station, though the embodiment also can be used in other applications, such as the factory interface. Again, other applications will be apparent to those of working skill in this technological field.

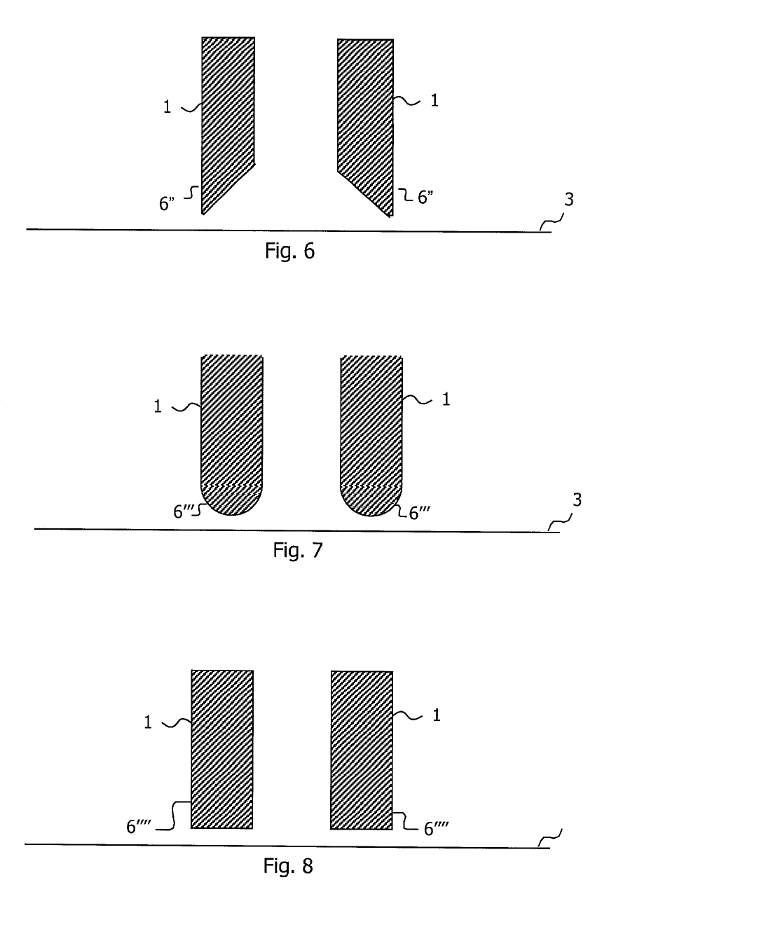

It should be noted that the tip 6 of the tube or slot can have a variety of shapes. In FIG. 1, the tip 6 has a conical configuration. In FIG. 3, the tip 6′ has the shape of a truncated cone. In FIG. 4, the tip 6′ has the same shape as in FIG. 3, but the tip is on the outer perimeter of the tube/slot 11, rather than the inner perimeter. In. FIG. 5, the points of the tip 6″ are one-sided, rather than two-sided, as in FIG. 1. In FIG. 6, the points of the tip 6″ are the same as in FIG. 5, but as in FIG. 4, the tip is on the outer perimeter of the tube/slot 11, rather than the inner perimeter. In FIG. 7, the tip 6′″ has a rounded shape. In FIG. 8, the tip 6′″ is flat. All of these tip configurations can be used with either of the embodiments.

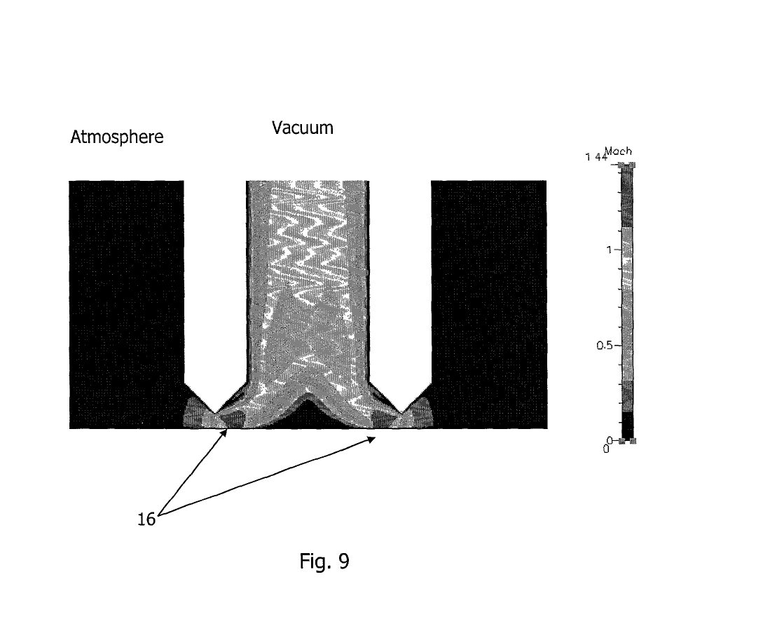

FIG. 9 is a gas flow velocity plot for the tip configuration and embodiment of FIG. 1, in which there is a vacuum inside the tube or slot, and gas is pulled into the tube or slot. The results were simulated using well-known computational fluid dynamics techniques, using values which yielded the various gas flow speeds shown with different shading. As can be seen from FIG. 9, transonic flow with a maximum speed of Mach 1.4 exists in a diverging section 16 of the tube tip, which is where the shock wave would occur. The high velocity gradient seen near the wafer produces a shear stress high enough to dislodge particles. Also in FIG. 9, the pressure at the tube tip exit with diameter 0.25 inch is about 375 bars for a gas flow rate of 7 liters/sec. The gap is roughly 0.8 mm.

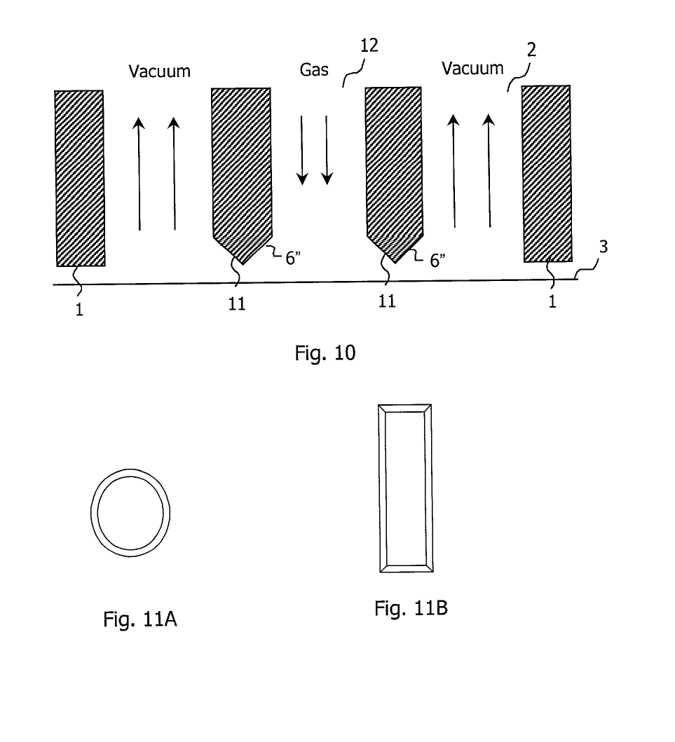

FIG. 10 shows another embodiment of the present invention, which combines features of FIGS. 1 and 2 described above. In FIG. 10, the cleaning apparatus comprises two concentric tubes or slots 11, 1. The tube/slot 11 is connected to a gas source which supplies the gas into the area. The second tube/slot 1 is connected to a vacuum pump, and so removes the gas and the dislodged contaminant particles from the wafer. In the embodiment of FIG. 10, the standing shock wave is formed in the controlled gap between the tube/slot 11 and the wafer/reticle. As will be appreciated, this embodiment combines the use of a vacuum with the use of gas flow beyond reliance on ambient atmosphere.

Finally, FIGS. 11A and 11B are plan views of either a tube or a slot which may be used in either embodiment in accordance with the invention.

Desired values for the size of the gap between the tube(s)/slot(s) 1, 11 and the wafer/reticle 3 are determined using fluid dynamics equations or computational fluid simulation, which are well within the knowledge of a person skilled in the art. The size of the gap depends on the diameter of the tube, as well as the properties, pressure and the velocity of the gas. For example, a cleaning device utilizing a conventional roughing pump (1-2 liters/sec) pumping to a pressure of 0.75 torr and a tube with opening of 5 mm diameter may require a gap of 0.5-3.0 mm in order to form a shock wave.

Although the invention has been described herein with reference to preferred embodiments thereof, it would be readily appreciated by those of skill in the art that numerous modifications in form and detail can be effected therein without departing from the scope and spirit of the invention. Accordingly, the invention is defined by the following claims.

What is claimed is:

1. Apparatus for removing particles from a surface of an article to be cleaned, said apparatus comprising:
a pump; and
a first tube or slot connected at one end to said pump so as to create a flow of a first gas in said first tube or slot, and having the other end substantially facing said surface;
wherein a juxtaposition of said first end and said surface, together with said flow of said first gas in said first tube or slot, forms a shock wave sufficient to dislodge said particles from said surface of said article.

2. An apparatus as claimed in claim 1, wherein said flow of said first gas in said first tube or slot results from a pressure differential between an inside of said first tube or slot, and an outside of said first tube or slot.

3. An apparatus as claimed in claim 2, wherein said pressure differential is such that a pressure in said first tube or slot is less than a pressure outside of said first tube or slot.

4. An apparatus as claimed in claim 3, wherein said pump is a vacuum pump.

5. An apparatus as claimed in claim 2, wherein said pressure differential is such that a pressure in said first tube or slot is greater than a pressure outside of said first tube or slot.

6. An apparatus as claimed in claim 5, wherein said pump pumps gas into said first tube or slot.

7. An apparatus as claimed in claim 1, further comprising means for effecting relative movement between said first tube or slot and said surface.

8. An apparatus as claimed in claim 7, wherein said means for effecting relative movement comprises means for moving said first tube or slot across said surface in raster fashion.

9. An apparatus as claimed in claim 7, wherein said means for effecting relative movement comprises means for rotating said article, and means for passing said first tube or slot between a center of said article and a perimeter of said article.

10. An apparatus as claimed in claim 7, wherein said means for effecting relative movement causes relative movement between one or more particular areas of said surface, and said first tube or slot.

11. An apparatus as claimed in claim 10, whereby one or more particular areas of said surface are cleaned to a greater extent than other areas of said surface.

12. An apparatus as claimed in claim 1, wherein a tip of said other end of said first tube or slot has one of a half-conical shape, a truncated half-conical shape, a conical shape, or a rounded shape.

13. An apparatus as claimed in claim 1, wherein said other end of said first tube or slot is disposed so as to form a predetermined gap between said surface and said first tube or slot, said shock wave being formed in said gap.

14. An apparatus as claimed in claim 1, further comprising a further tube or slot, concentric with and inside said first tube or slot, for providing a flow of a second gas toward said surface of said article, said shock wave being formed by flow of said second gas in said first tube or slot.

15. An apparatus as claimed in claim 14, wherein said second gas is the same as said first gas.

16. An apparatus as claimed in claim 14, wherein a vacuum is formed in said further tube or slot.

17. An apparatus as claimed in claim 1, further comprising a plurality of said tubes or slots, each having a respective end substantially facing said surface, and each of said tubes or slots having a pressure within that is sufficiently different from a pressure without to form a shock wave at said respective end.

18. An apparatus as claimed in claim 1, further comprising a further tube or slot juxtaposed with respect to an opposite surface of said article from said first tube or slot so as to effect cleaning of said surface and said opposite surface.

19. An apparatus as claimed in claim 1, wherein said article is a semiconductor wafer.

20. An apparatus as claimed in claim 1, wherein said article is a reticle.

21. A method of removing particles from a surface of an article to be cleaned, said method comprising providing a first tube or slot with one end connected to a pump and the other end disposed substantially facing said surface, and providing a flow of a first gas in said first tube or slot so as to induce a pressure differential between an inside of said first tube or slot, and an outside of said first tube or slot, said pressure differential forming a shock wave sufficient to dislodge said particles from said surface.

22. A method as claimed in claim 21, wherein providing said flow of said first gas comprises reducing a pressure in said first tube or slot with respect to a pressure outside of said first tube or slot.

23. A method as claimed in claim 21, wherein providing said flow of said first gas comprises increasing a pressure in said first tube or slot with respect to a pressure outside of said first tube or slot.

24. A method as claimed in claim 21, further comprising effecting relative movement between said first tube or slot and said surface.

25. A method as claimed in claim 24, wherein said effecting relative movement comprises moving said first tube or slot across said surface in raster fashion.

26. A method as claimed in claim 24, wherein said effecting relative movement comprises rotating said article, and passing said first tube or slot between a center of said article and an external perimeter of said article.

27. A method as claimed in claim 24, wherein said effecting relative movement causes relative movement between one or more particular areas of said surface, and said tube or slot.

28. A method as claimed in claim 27, whereby one or more particular areas of said surface are cleaned to a greater extent than other areas of said surface.

29. A method as claimed in claim 21, wherein said providing said first tube or slot comprises disposing said other end so as to form a predetermined gap between said surface and said first tube or slot, said shock wave being formed in said gap.

30. A method as claimed in claim 21, further comprising providing a further tube or slot, concentric with and inside said first tube or slot, for providing a flow of a second gas within said further tube or slot, said shock wave being formed by flow of said second gas in said first tube or slot.

31. A method as claimed in claim 30, wherein said second gas is the same as said first gas.

32. A method as claimed in claim 30, further comprising forming a vacuum in said further tube or slot.

33. A method as claimed in claim 21, further comprising providing a plurality of said tubes or slots, each of said tubes or slots having a respective end substantially facing said surface, each of said tubes or slots having a pressure within that is sufficiently different from a pressure without to form a shock wave at said respective end.

34. A method as claimed in claim 21, further comprising providing a further tube or slot juxtaposed with respect to an opposite surface of said article from said first tube or slot so as to effect cleaning of said surface and said opposite surface.

35. A method as claimed in claim 21, wherein said article is a semiconductor wafer.

36. A method as claimed in claim 21, wherein said article is a reticle.
